(19) United States
(12) Patent Application Publication
(10) Pub. No.: US 2008/0010329 A1
(43) Pub. Date: Jan. 10, 2008

(54) Method and computer program product for circuit analysis and circuit simulation device

(75) Inventor: Kimihiko Kuwada, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/822,133

(22) Filed: Jul. 2, 2007

(30) Foreign Application Priority Data
Jul. 6, 2006 (JP) 2006-187136

(51) Int. Cl. G06F 15/00

(52) U.S. Cl. 708/200

(57) ABSTRACT

A method and a computer program product for a circuit analysis and a circuit simulation device, capable of increasing an analysis speed for circuit analysis, the circuit simulation device includes a circuit matrix generation unit for generating a coefficient matrix based on netlist information corresponding to a circuit to be analyzed, a fill-in parameter counting unit for acquiring a fill-in parameter for the coefficient matrix, an analysis selection unit for selecting either of the direct method or the iterative method as a solution-producing method for the coefficient matrix based on the fill-in parameter, a matrix size of the coefficient matrix and number of non-zero elements of the coefficient matrix and analyzing units for producing a solution of the coefficient matrix as an analysis result of the circuit by a selected one of the direct method and the iterative method.

### BACKGROUND OF THE INVENTION

1. Field of the Invention

The present invention relates to circuit analysis methods, circuit analysis programs and circuit simulation devices and, in particular, to a circuit analysis method, a circuit analysis program and a circuit simulation device for analyzing a delay time of a signal in a circuit.

2. Description of Related Art

A circuit simulator is a tool for EDA (Electronic Design Automation) simulating an analog operation of an electronic circuit. One of typical circuit simulators is SPICE (Simulation Program with Integrated Circuit Emphasis). The circuit simulator generates circuit equations (linear simultaneous equations) based on connection information of transistor levels in circuits and circuit element information such as electric characteristics (netlist) and outputs dc characteristics, time response and frequency response of node voltages and currents passing through elements in circuits by solving the equation. As described above, the circuit simulator is an essential EDA tool for circuit design of transistor levels, particularly designs of full custom LSIs, memory LSIs and analog ICs.

As methods for solving linear simultaneous equations in the circuit simulator, the following two methods: the direct method and the iterative method are conventionally available. The direct method transforms a coefficient matrix composed of (n) elements of linear simultaneous equations to an upper triangular matrix (advance elimination process), as typified by Gaussian elimination method and sequentially produces solutions from the last row of the transformed upper triangular matrix (back-substitution process). The iterative method produces approximate solutions of equations by giving arbitrary initial values to solutions and improving accuracy of the solutions using a repetition formula. As the iterative method, the following two methods: steady method such as Gauss-Seidel method and unsteady method such as CG (Conjugate Gradient) method are conventionally available.

The direct method can produce solutions with very few theoretical errors, basically from any simultaneous equation. Accordingly, the direct method can be applied to any type device or circuit configuration for general-purpose use. On the other hand, the iterative method has a problem: rounding errors are apt to gather. Accordingly, as a current method for solving simultaneous equations (coefficient matrix), circuit simulators using the direct method have become more widespread. Conventional technologies of circuit simulators using the direct method are disclosed, for example, in Japanese Patent Laid-Open Nos. 2001-290796, 9-319784 and 10-011475, respectively.

However, because modern study indicates that the convergence performance of the iterative method has been remarkably improved and rounding errors have been restrained from gathering, incorporation of the iterative method into the circuit simulators are increasingly under study.

The coefficient matrix calculated by circuit simulation is such a Sparse matrix that almost all the matrix elements are zero. Accordingly, in the case of small coefficient matrix size, the direct method is effective. In other words, the direct method can produce exact simulation results in a short calculating time when the scale of a circuit to be simulated (number of circuit elements) is relatively small. However, as the circuit scale is larger, the size of coefficient matrix become larger, so that memory usage of a circuit simulation significantly increases and analysis time becomes longer. Therefore, the practical limitation on an applicable circuit scale is said to be about 20,000 to 30,000 elements. On the other hand, the iterative method requires longer calculation time than the direct method when the size of a coefficient matrix is small, because of the time of repetition required to produce solutions. However, the iterative method, without addition of non-zero-element by fill-in-coefficient matrix, hereinafter referred to as fill-in-parameter, will not cause an increase in the amount of memory in use like the direct method. Accordingly, in the case of large circuit scale (coefficient matrix size), the iterative method can execute circuit analysis in a shorter time than the direct method. For this reason, the direct method is effective in circuit analysis for a small-scaled circuit, while the iterative method is effective in circuit analysis for a large-scaled circuit.

Recently, in designing printed circuit boards implemented with LSIs of high-speed operation, a circuit simulator has become an essential tool. Accordingly, the importance of such a circuit simulator capable of analyzing large-scaled circuits at high speed and with high precision has become greater than ever before. Preferably, the iterative method is applied to an analysis method to analyze such large-scaled circuits at high speed.

However, the present inventor has recognized that only from the size of coefficient matrix (circuit scale), it is difficult to exactly estimate which of the direct method and the iterative method can perform circuit simulation at higher speed. A relationship between computing frequency per analysis by the direct method and the iterative method and size of coefficient matrix is shown below. If a size of a coefficient matrix is taken as N, a percentage (matrix density) of non-zero elements before addition of fill-in parameters to a coefficient matrix as λ and a percentage (matrix density) of fill-in parameters to a coefficient matrix as μ, the computing frequency per analysis by the direct method and the iterative method is as expressed by equations (1) and (2). The Gauss-elimination method is used as the direct method and BiCGstab method is used as the iterative method, respectively.

$$[ Formula 1 ]$$

$$\begin{matrix}{( λ + μ )}^{2} \cdot {\sum }_{x = 1}^{N - 1} {x}^{2} = {( λ + μ )}^{2} \cdot ( {( N - 1 )}^{3} - 1 ) \\ [ Formula 2 ] & ( 1 ) \\ ITR \cdot ( 2 λ {N}^{2} + 12 N + 5 ) & ( 2 )\end{matrix}$$

Where, ITR is a repetition frequency.

FIG. 12 is a simulation result showing a relationship between computing frequency per analysis by the direct method and the iterative method with λ=0.1 and ITR=1,000 and the size of a coefficient matrix. Referring to FIG. 12, without fill-in parameters, that is, in the case of μ=0, the iterative method can perform circuit simulation at higher speed if the size of a coefficient matrix exceeds 20,000. However, the number of fill-in parameters greatly changes with a configuration of non-zero elements even if a value of λ is the same. Accordingly, the iterative method may be capable of making an analysis with lower computing frequency even if the size of a coefficient matrix is less than 20,000. For example, in the case of λ=0.5, the size of a coefficient matrix is 560 when analysis speed by the iterative method exceeds that by the direct method. The computing time (computing frequency) of circuit simulation by the direct method cannot be estimated from the size of a coefficient matrix alone. Accordingly, only from the size of coefficient matrix (circuit scale), it is difficult to exactly estimate which of the direct method and the iterative method can perform circuit simulation at higher speed.

### SUMMARY

The present invention seeks to solve one or more of the above problems, or to improve upon those problems at least in part.

In one embodiment, a circuit simulation device includes a circuit matrix generation unit for generating a coefficient matrix based on netlist information corresponding to a circuit to be analyzed, a fill-in parameter counting unit for acquiring a fill-in parameter for the coefficient matrix, an analysis selection unit for selecting either of the direct method or the iterative method as a method for producing a solution of a coefficient matrix based on the fill-in parameter, a matrix size of the coefficient matrix and number of non-zero elements of the coefficient matrix and an analyzing units for producing a solution of the coefficient matrix as an analysis result of the circuit by the selected method.

By use of the simulation device, the analysis time of circuit can be reduced.

### BRIEF DESCRIPTION OF THE DRAWINGS

The above and other objects, advantages and features of the present invention will be more apparent from the following description taken in conjunction with the accompanying drawings, in which:

FIG. 1 is a view showing a configuration of the first embodiment of the circuit simulation device 10 according to the present invention;

FIG. 2 is a block diagram showing a configuration of a circuit analysis program according to a first embodiment of the present invention;

FIG. 3 is an example of algorithms of an advance process by the direct method according to the present invention;

FIG. 4 is an example of algorithms of the iterative method according to the present invention;

FIGS. 5A and 5B are views for describing fill-in parameters added to a coefficient matrix for advance elimination;

FIG. 6 is a block diagram showing a configuration of a circuit analysis program according to the first embodiment of the present invention;

FIG. 7 is a flowchart showing operation of direct method computation processing by a direct method analyzing unit;

FIG. 8 is a flowchart showing operation of iterative method computation processing by an iterative method analyzing unit;

FIGS. 9A and 9B are examples of simulation results showing differences between circuit analysis time by the direct method and the iterative method;

FIG. 10 is a block diagram showing a configuration of a circuit analysis program according to a second embodiment of the present invention;

FIG. 11 is a flowchart showing operation of circuit analyzing according to the second embodiment of the present invention; and

FIG. 12 is an example of simulation results showing a relationship between computing frequencies per analysis for matrix sizes by the direct method and the iterative method.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

With reference to the accompanying drawings, description will be given below of preferred embodiments of a circuit simulation device according to the present invention. In this embodiment, an example is described on a computer apparatus installed with a circuit simulator using the direct method and the iterative method as solution-producing methods, hereinafter referred to as a “circuit simulation device 10”. The same or similar reference characters are the same, similar or equivalent components on drawings.

### 1. First Embodiment

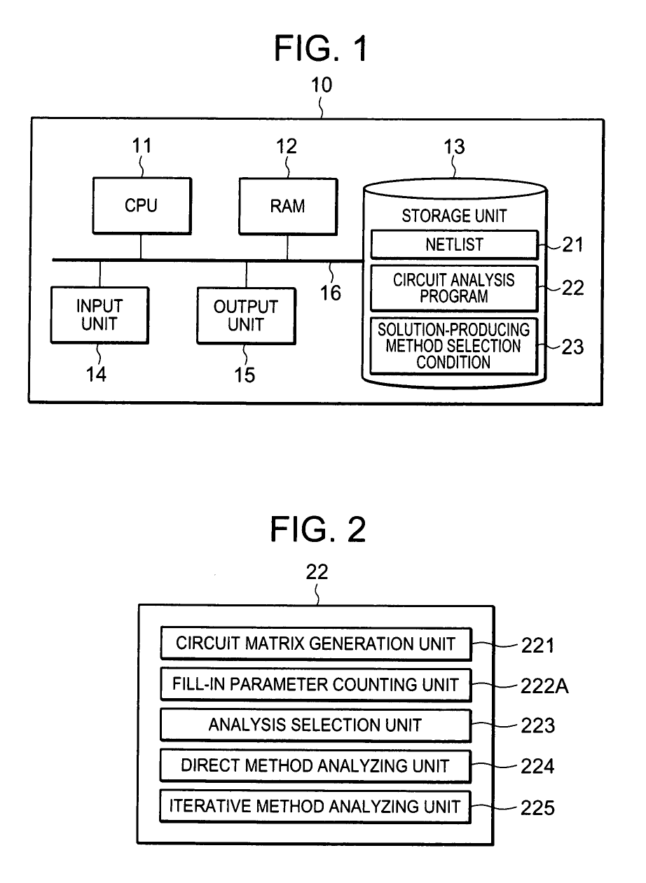

A circuit simulation device 10 according to a first embodiment analyzes electronic circuits using either of the direct method or the iterative method. At this time, the circuit simulation device 10 selects a solution-producing method capable of high-speed computation, of the direct method and the iterative method, based on the number of fill-in parameters to be applied to coefficient matrices to be analyzed and executes circuit analysis. Referring now to FIGS. 1 to 9, the first embodiment of the circuit simulation device 10 according to the present invention will be described in detail below.

### (Configuration)

Referring to FIGS. 1 to 5, the first embodiment of the circuit simulation device 10 according to the present invention will be described below. FIG. 1 is a view showing a configuration of the first embodiment of the circuit simulation device 10 according to the present invention. Referring to FIG. 1, the circuit simulation device 10 according to the present invention is composed of a CPU 11, a RAM 12, a storage unit 13, an input unit 14 and an output unit 15 mutually connected through a bus 16. The storage unit 13 is an external storage such as a hard disk or memory. Moreover, the input unit 14 outputs various types of data to the CPU 11 and the storage unit 13 by operation of a user of a keyboard, a mouse and so on. The output unit 15 visibly outputs, to a user, the results of circuit analysis which are illustrated on a monitor or a printer and are output from the CPU 11.

The CPU 11 executes a circuit analysis program 22 within the storage unit 13 in response to an input from the input unit 14 to perform circuit analysis. At this time, various types of data and programs from the storage unit 13 are temporarily stored in the RAM 12, and the CPU 11 executes various types of processing using data within the RAM 12.

The storage unit 13 stores a netlist 21, the circuit analysis program 22 and a solution-producing method selection condition 23. The netlist 21 includes circuit connection information, characteristics of respective elements and analysis information. Specifically, the netlist 21 includes an element card describing the connections, types and sizes (number of elements) of elements constituting a circuit to be analyzed, parameters of device models of nonlinear active elements such as diodes and transistors and condition information (initial values, etc.) controlling a method for circuit analysis, of elements constituting the circuit. The circuit analysis program 22 is executed by the CPU 11 and analyzes the delay time of a node voltage and an in-element current in a circuit to be analyzed. The solution-producing method selection condition 23 is a condition information for determining which of the direct method and the iterative method should be taken as a solution-producing method. The circuit simulation device 10 according to the present invention compares computing frequencies of coefficient matrices by each of the direct method and the iterative method with each other, and selectively determines a solution-producing method. The computing frequency by the iterative method, changing with an initial value to be given in producing solutions of coefficient matrices, is set with a predetermined value. The storage unit 13 stores the predetermined value as a solution-producing method selection condition 23.

The circuit analysis program 22 is a circuit simulator performing circuit simulation. The circuit program 22 implements, by execution of CPU 11, respective functions of a circuit matrix generation unit 221, a fill-in parameter counting unit 222A, an analysis selection unit 223, a direct method analyzing section 224 and an iterative method analyzing unit 225.

The circuit matrix generation unit 221 produces a circuit equation (coefficient matrix) for an electronic circuit to be analyzed based on condition information to be input from the input unit 14 and the netlist 21 in a storage unit 18. At this time, a formulation method for a circuit equation mainly called a modified node method is used. Moreover, a device model using an analysis formula is used. To calculate a current passing through individual transistors, the device model is a data file in which actually measured electric characteristics (current−voltage characteristic and capacity−voltage characteristic) are modeled. The modified node method produces a circuit equation based on the Kirchhoff's current and voltage laws with a node voltage and a current running through a voltage source element in a circuit as variables. A circuit equation produced in this way becomes a nonlinear simultaneous differential equation. The circuit matrix generation unit 221 combines an implicit integration method with Newton's iterative method and transforms the nonlinear simultaneous differential equation to a simultaneous algebraic equation to obtain a circuit equation (coefficient matrix) for a circuit to be analyzed. Specifically, a simultaneous linear equation is expressed as Ax=b. Where, if a simultaneous linear equation to be solved is a (m) elements of simultaneous equation, A is a matrix in (m) rows and (m) columns, x is an unknown matrix in one row and (m) columns and b is a matrix in one row and (m) columns.

The fill-in parameter counting unit 222A performs advance elimination process for a coefficient matrix generated by the circuit matrix generation unit 221 and counts the number of fill-in parameters added to the coefficient matrix in the process.

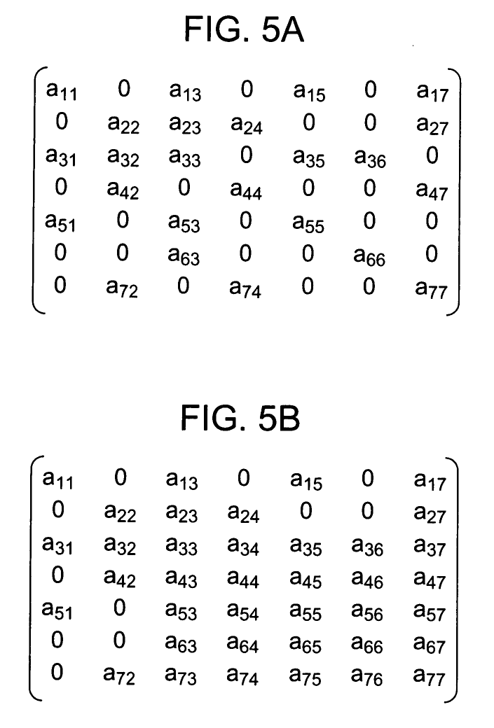

The fill-in parameter will be described below. For example, during advance elimination process by Gaussian elimination method, a value (non-zero element) in a matrix element (zero element) which was originally zero in a coefficient matrix may be included. Addition of the non-zero element is referred to as fill-in. A filled-in non-zero element is referred to as a fill-in parameter herein. The advance elimination process refers to a process of transforming a coefficient matrix to an upper triangular matrix. For example, if a matrix size N of a coefficient matrix is “n”, matrix elements in (i) rows and (j) columns (i<j) from the first column to (n−1)th column are sequentially transformed to zero elements (elimination of matrix elements) to produce an upper triangular matrix. As an elimination method of matrix elements, for example, if an element in (j)th row and (i)th column is transformed to a zero element, a value obtained by multiplying a matrix element in (i)th row by aⱼₖ/aᵢᵢ (1≦k≦n) is subtracted from an element in (j)th row. For example, if a coefficient matrix (matrix size: N=7) as shown in FIG. 5A is transformed to an upper triangular matrix by the advance elimination process, a matrix element in the 4th row and 3rd column becomes a non-zero element when a matrix element in the 4th row and 2nd column is deleted. The fill-in parameter counting unit 222A recognizes, as a fill-in parameter, the matrix element in the 4th row and 3rd column the zero element of which has been changed to the non-zero element. If the advance elimination process is performed from 1st to 6th columns against FIG. 5A, a coefficient matrix after addition of the fill-in parameter is as shown in FIG. 5B. The fill-in parameter counting unit 222A recognizes matrix elements a43, a73, a34, a54, a64, a45, a65, a75, a46, a56, a76, a37, a57 and a67 added in FIG. 5B as fill-in parameters and counts the quantity.

The analysis selection unit 223 calculates a value based on computing frequency by the direct method according to a calculation method described later, compares the calculation results with the solution-producing method selection condition 23 corresponding to a circuit to be analyzed and selectively determines an optimum solution-producing method from either of the direct method or the iterative method. At this time, a value based on the computing frequency by the direct method is calculated in consideration of the number of fill-in parameters in coefficient matrices.

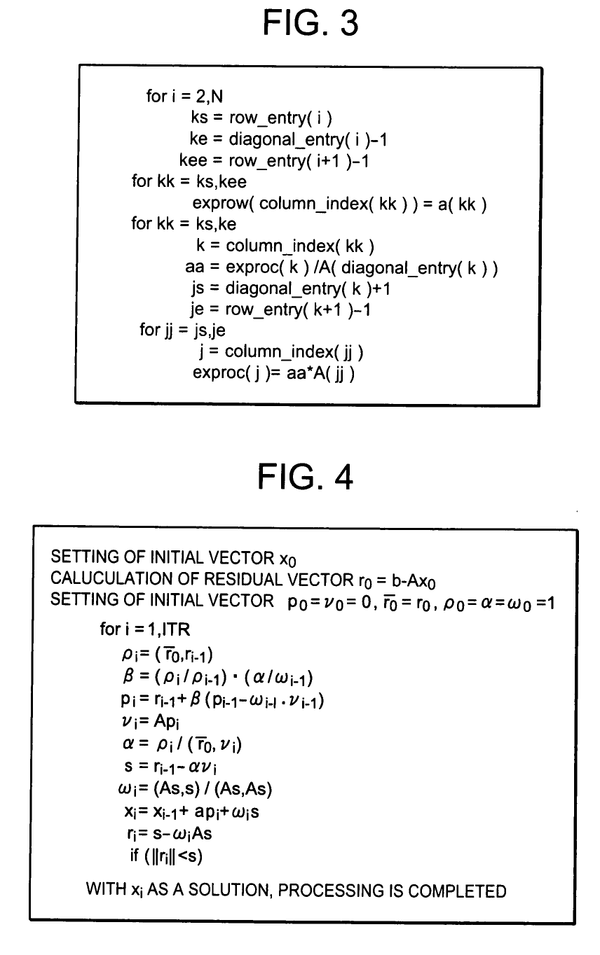

The direct method analyzing unit 224 produces solutions for the coefficient matrices generated by the circuit matrix generation unit 221 through the direct method and outputs desired analysis results. This embodiment uses the Gaussian elimination method as the direct method. FIG. 3 is an example of algorithms of an advance process by the direct method analyzing unit 224. Where, N is a size of a coefficient matrix, row_entry is an index of a non-zero element at the leading edge in each row of coefficient matrices, diagonal_entry is an index of a diagonal element in each row of coefficient matrices, column_index is a column number of each non-zero element and A is a coefficient matrix.

The iterative method analyzing unit 225 produces solutions for the coefficient matrices generated by the circuit matrix generation unit 221 through the iterative method and outputs desired analysis results. This embodiment uses BiCGstab (Bi-Conjugate Gradient Stabilized) method as the iterative method. FIG. 4 is an example of solution-producing algorithms in the iterative method analyzing unit 225. Where, A is a coefficient matrix, xo is an initial vector and ITR is a repetition frequency. The direct method analyzing unit 224 or the iterative method analyzing unit 225 repeatedly produces solutions in each analysis time until a calculated solution has satisfied a convergence condition set in a netlist. The convergence condition indicates that the above-described solution-producing process is repeated and a displacement of an obtained unknown matrix x is accommodated in a fixed range.

As described above, the circuit simulation device 10 according to the first embodiment includes an analysis selection unit 223 for selecting a solution-producing method for coefficient matrices from values based on analysis time in consideration of the number of fill-in parameters in coefficient matrices. Accordingly, the circuit simulation device 10 according to this embodiment provides a solution-producing method capable of high-speed processing with higher precision than a conventional one that selects a solution-producing method based on a circuit scale.

Selection operation of the solution-producing method for the circuit simulation device 10 according to the first embodiment and detail of the solution-producing method selection condition 23 will be described below.

### (Operation)

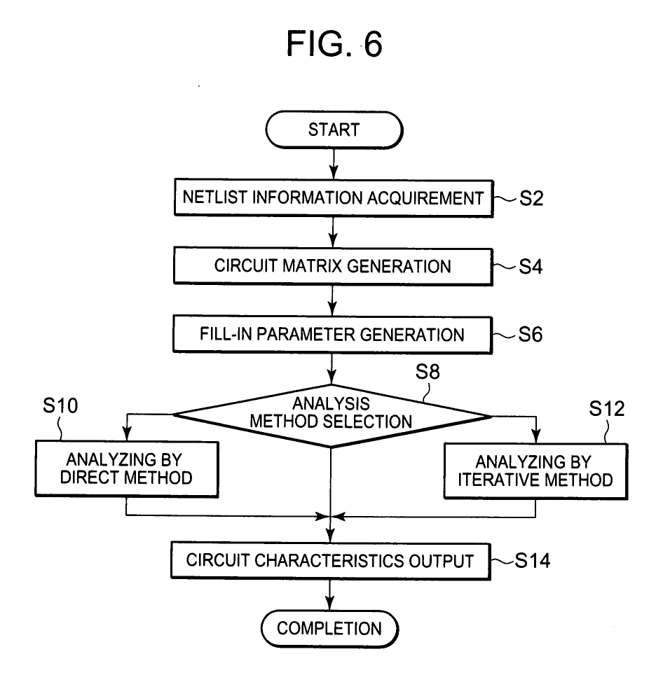

Referring to FIGS. 6 to 9, the following description will be made on the operation of the circuit simulation device 10 according to the present invention. FIG. 6 is a flowchart showing circuit simulation operation of the circuit simulation device 10 according to the first embodiment. Firstly, the circuit matrix generation unit 221 identifies a circuit to be analyzed based on condition information input from the input unit 14 and acquires a netlist 21 corresponding to the circuit from the storage unit 13 (step S2). The circuit matrix generation unit 221 generates a circuit equation (coefficient matrix) as a linear simultaneous equation using the acquired netlist 21 (step S4). At this time, the circuit matrix generation unit 221 derives the number “a” of non-zero elements in the generated coefficient matrix and a coefficient matrix size N.

The fill-in parameter counting unit 222A performs advance elimination for a coefficient matrix produced by the circuit matrix generation unit 221 and counts the number “b” of fill-in parameters (step S6). The analysis selection unit 223 calculates computing frequency per analysis in producing solutions for coefficient matrices, using the number “a” of non-zero elements derived by the circuit matrix generation unit 221, a size N of coefficient matrices and the number “b” of fill-in parameters counted by the fill-in parameter counting unit 222A. In addition, the analysis selection unit 223 compares the calculated computing frequency with the solution-producing method selection condition 23 and selects an optimum solution-producing method from the direct method or the iterative method (step S8).

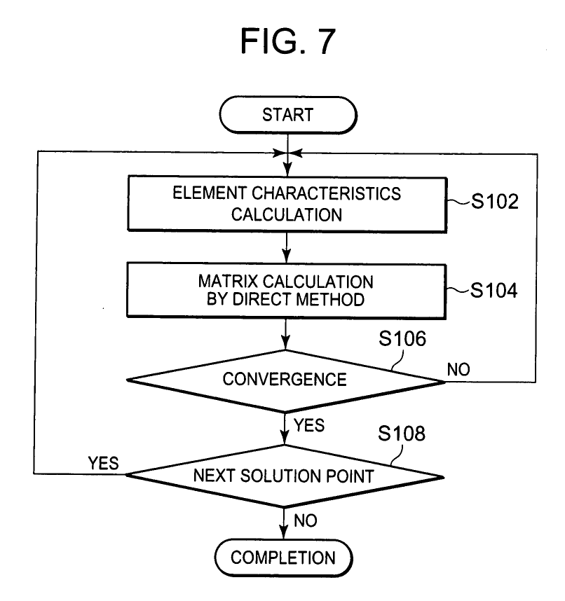

When the analysis selection unit 223 selects the direct method, the direct method analyzing unit 224 starts, a matrix equation subjected to advance elimination by the fill-in parameter counting unit 222A is solved by the direct method, and circuit characteristics such as potentials of contacts of a circuit to be analyzed and current values of elements are output as solution-producing results (steps S10 and S14). Referring to FIG. 7, the detail of solution-producing by the direct method will be described below. The direct method analyzing unit 224 substitutes element characteristics based on a netlist into a coefficient matrix with a fill-in parameter added by the fill-in parameter counting unit 222A (step S102). Next, computation by the direct method is performed for the coefficient matrix substituted with the element characteristics (step S104). At this time, the direct method analyzing unit 224 repeats processing of steps S102 and S104 until a convergence condition with a calculated solution set in a netlist has been satisfied (step S106). When a solution is converged, the solution is output and a solution of a coefficient matrix is computed at the next analysis point (analysis time) (step S108 and steps S102 to S106). When solutions are calculated at all the set analysis points, producing solutions for coefficient matrices are completed (no step S108). As described above, the direct method analyzing unit 224 produces solutions for coefficient matrices of a circuit to be analyzed by the direct method and outputs analysis results at each analysis point.

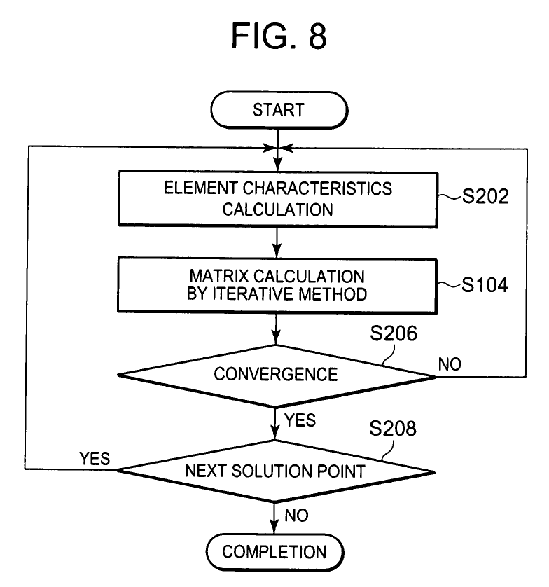

When the analysis selection unit 223 selects the iterative method, the iterative method analyzing unit 225 starts, a coefficient matrix generated by the circuit matrix generation unit 221 is solved by the iterative method, and circuit characteristics such as potentials of contacts of a circuit to be analyzed and current values of elements are output as solution-producing results (steps S12 and S14). Referring to FIG. 8, the detail of solution-producing by the iterative method will be described below. The iterative method analyzing unit 225 substitutes element characteristics based on a netlist into a coefficient matrix generated by the circuit matrix generation unit 221 (step S202). Next, computation by the iterative method is performed for the coefficient matrix substituted with the element characteristics (step S204). At this time, the iterative method analyzing unit 225 repeats processing of steps S202 and S204 until a convergence condition with a calculated solution set in a netlist has been satisfied (step S206). When a solution is converged, the solution is output and a solution of a coefficient matrix is computed at the next analysis point (analysis time) (step S208 and steps S102 to S106). When solutions are calculated at all the set analysis points, producing solutions for coefficient matrices are completed (no step S108). As described above, the iterative method analyzing unit 225 produces solutions for coefficient matrices of a circuit to be analyzed by the iterative method and outputs analysis results at each analysis point.

Now, detail of solution selection processing by the analysis selection unit 223 will be described below. For selection of a solution-producing method, preferably, computing frequency by the direct method is compared with that by the iterative method and a solution-producing method with low computing frequency is selected. Accordingly, it is supposed that computing frequencies calculated by the above equations (1) and (2) are compared with each other. On the other hand, recently, a size N of a coefficient matrix of an electronic circuit to be analyzed is N>>1, therefore, if the size is N>>1 in this embodiment as well, comparison processing is performed only for a term most dominant in each of equations (1) and (2) by an approximate equation. An equation (3) is obtained by approximating the equation (1). An equation (4) is obtained by approximating the equation (2).

### [Formula 3]

(λ+μ)²·N³ (3)

### [Formula 4]

2·ITR·λ·N² (4)

If the number “a” of non-zero elements not including fill-in parameters of a coefficient matrix and the number “b” of the fill-in parameters are used, the equation (3) becomes an equation (5) and the equation (4) becomes an equation (6).

$$[ Formula 5 ] \\ \begin{matrix}\frac{{( a + b )}^{2}}{N} \\ [ Formula 6 ] & ( 5 ) \\ 2 \cdot ITR \cdot a & ( 6 )\end{matrix}$$

In other words, a selection equation for selecting a solution-producing method is as shown in an equation (7).

$$[ Formula 7 ]$$

$$\frac{{( a + b )}^{2}}{a \cdot N} > 2 \cdot ITR \qquad ( 7 )$$

The analysis selection unit 223 selects the iterative method if the left side is larger than the right side of the equation (7) and the direct method if smaller, respectively. A repetition frequency ITR varies with performance of the iterative method and accuracy of a given initial value. Accordingly, the repetition frequency ITR to be set to the right side of the equation (7) is set with an average value (average repetition frequency) at each analysis time or predetermined values based on an empirical rule described later. In this embodiment, the right side (repetition frequency ITR×2=Fill) of the equation (7) is set at the storage unit 13 as a condition (solution-producing method selection condition) for selecting a solution-producing method for a coefficient matrix.

Both of the direct method and the iterative method as a matrix computation method have a plurality of types of solution-producing methods. For example, as the direct method, there are solutions such as LU decomposition and Cholesky factorization in addition to Gaussian elimination method. As the iterative method, there are solutions such as Jacobi method, Gauss-Seidel method, SOR (Successive Over-Relaxation) method and GMRES (Generalized Minimal Residual) method in addition to BicGstab method. In selecting a solution-producing method, simple comparison between the equations (1) and (2) can support the selection only when Gaussian elimination method is used as the direct method or only when BicGstab method is used as the iterative method. However, the analysis selection unit 223 according to the present invention compares computing frequency using terms having the highest dependency of each of the equations (1) and (2) with each other, by which high-speed matrix computation method (solution-producing method) can be selected regardless of a plurality of types of solution-producing methods of the direct method and the iterative method.

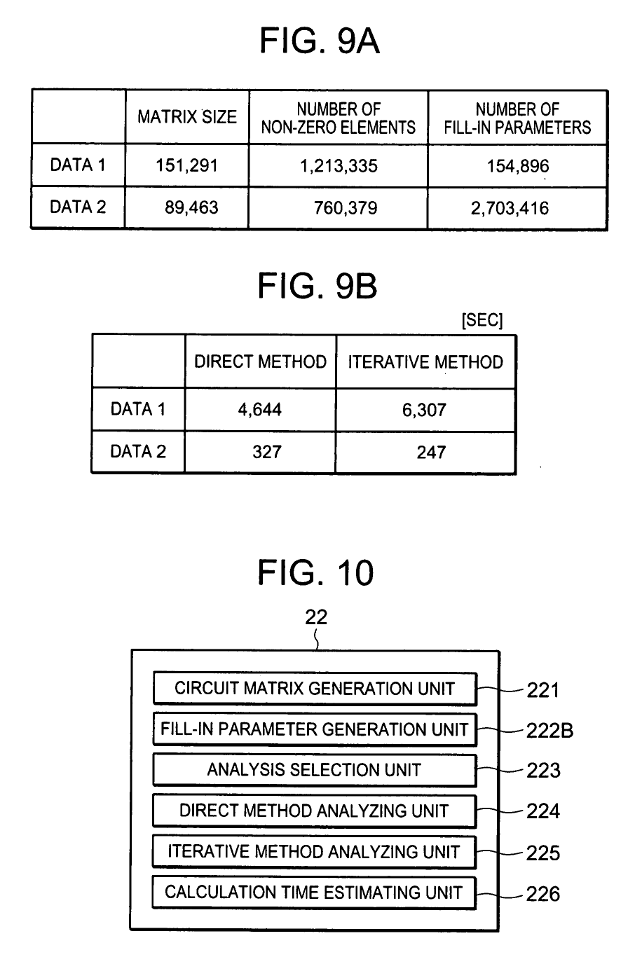

Referring to FIGS. 9A and 9B, setting examples of the solution-producing method selection condition 23 will be described below. FIG. 9A is a chart showing a coefficient matrix size N, number “a” of non-zero elements not including fill-in parameters and number “b” of fill-in parameters of data 1 and data 2 of two circuits to be analyzed. FIG. 9B is a chart showing each computing speed when circuit simulation is performed by the direct method and the iterative method for each of data 1 and data 2. FIG. 9A indicates that a matrix size N (151291) of data 1 is larger than a matrix size N (89463) of data 2. On the other hand, FIG. 9B indicates that the direct method has higher computing speed than the iterative method for data 1 and the iterative method has higher computing speed than the direct method for data 2. In other words, when a matrix size N of a circuit to be analyzed is between those of data 1 and data 2, a method for selecting a solution-producing method from the magnitude correlation of the matrix size N unavoidably will select a solution-producing method with low computing speed.

On the other hand, in this embodiment, if the left side of the equation (7) is calculated from the parameter shown in FIG. 9A, data 1 has 10.2 and data 2 has 176.4. In this case, a value between 10.2 and 176.4 is set as the solution-producing method selection condition 23. In this way, the solution-producing method selection condition 23 is set, by which the analysis selection unit 223 can exactly select a matrix computation method capable of high-speed computation even for an electronic circuit a matrix size N of which is between data 1 and data 2.

As described above, the circuit simulation device 10 according to the first embodiment selects a solution-producing method for a coefficient matrix capable of high-speed computation, using a matrix size N of coefficient matrix, number “a” of non-zero elements and number “b” of fill-in parameters. That is, a solution-producing method is selected based on the number of fill-in parameters added to the coefficient matrix. Accordingly, a solution-producing method computable at high speed can be selected from the iterative method and the direct method with high accuracy. This permits implementation of a circuit simulator with both of the direct method and the iterative method applied. Generally, a simulator only a large matrix size of which is to be analyzed, such as a device simulator, can be applied with only the iterative method computable at high speed for large-scaled computation. However, the iterative method has a slower computing speed for small-scaled computation than the direct method.

Circuits to be analyzed in a circuit simulator include not only large-scaled circuits but also small-scaled circuits. Accordingly, the emergence of a circuit simulator may be expected which is used by switching between the direct method and the iterative method according to the scale of the circuit to be analyzed, rather than using only the iterative method. Accordingly, in a case where the iterative method is applied to a simulator handling from small-scaled circuits to large-scaled circuits; such as a circuit simulator, a circuit simulation device is required which is used by switching between the direct method and the iterative method according to a circuit to be analyzed. However, in selecting a solution-producing method in consideration of only a size of a coefficient matrix, a solution-producing method with low computing speed may be selected. The present invention, selecting a solution-producing method in consideration of the number of fill-in parameters, provides exact selection of a solution-producing method computable at high speed for execution of analysis. This permits the iterative method to be applied to an electronic circuit simulator, which was not conventionally applied.

### 2. Second Embodiment

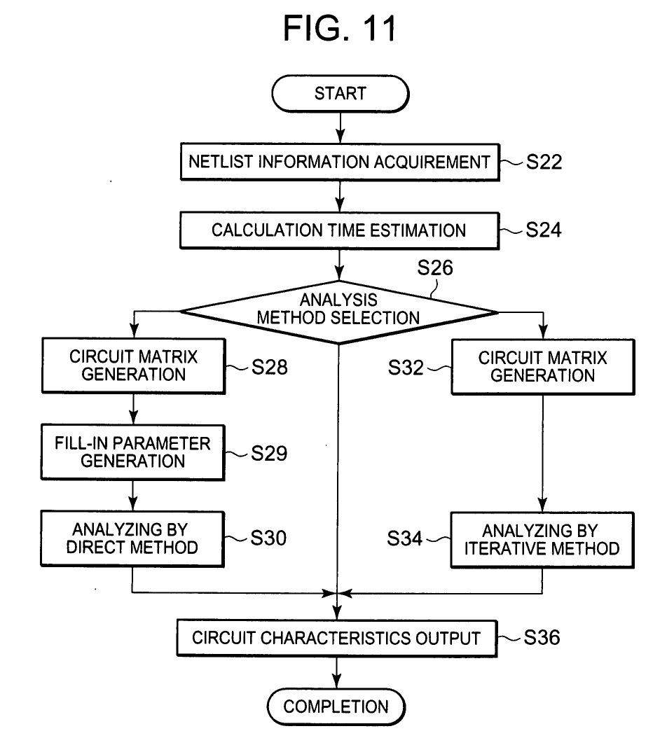

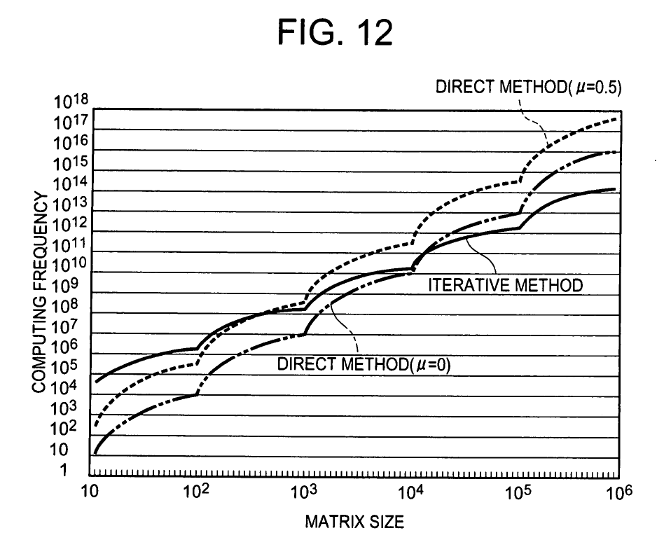

A circuit simulation device 10 according to a second embodiment, before generating a coefficient matrix of a circuit to be analyzed, estimates the number of non-zero elements of the coefficient matrix and the number of fill-in parameters, and selects either of the direct method or the iterative method based on the estimated value for implementation of circuit simulation. Referring now to FIGS. 10 and 11, the second embodiment of the circuit simulation device 10 according to the present invention will be described in detail below.

### (Configuration)

The circuit simulation device 10 according to the second embodiment has such a configuration as to further add a computation time estimating unit 226 to the circuit analysis program 22 according to the first embodiment, and includes a fill-in parameter generation unit 222B in place of the fill-in parameter counting unit 222A according to the first embodiment. The fill-in parameter generation unit 222B adds fill-in to a coefficient matrix after selection of the direct method as a solution-producing method for the coefficient matrix. The computation time estimating unit 226 estimates a matrix size of a matrix circuit of a circuit to be analyzed, the number of non-zero elements not including fill-in parameters and the number of fill-in parameters. Specifically, the computation time estimating unit 226, as disclosed in Japanese Patent Laid-Open No. 09-319784, generates a directed graph using a netlist 21 corresponding to the circuit to be analyzed and estimates the matrix size of the matrix circuit of the circuit to be analyzed, the number of non-zero elements not including the fill-in parameters and the number of the fill-in parameters from the directed graph.

An analysis selection unit 223 according to the second embodiment takes the estimated values by the computation time estimating unit 226 as a matrix size N, the number “a” of non-zero elements and the number “b” of fill-in parameters and selects a solution-producing method capable of high-speed computation from the direct method and the iterative method using the equation (7).

### (Operation)

Referring to FIG. 11, operation of the circuit simulation device 10 according to the second embodiment will be described below. FIG. 11 is a flowchart showing circuit simulation operation of the circuit simulation device 10 according to the second embodiment. Firstly, the circuit matrix generation unit 221 identifies a circuit to be analyzed based on condition information input from the input unit 14 and acquires a neck list 21 corresponding to the circuit from the storage unit 13 (step S22). The computation time estimating unit 226 represents a circuit matrix of a circuit to be analyzed as a directed graph illustrating the presence of a non-zero element aᵢⱼ as a side (j, i), referring to the acquired netlist 21 and obtains a coefficient matrix size N and the number “a” of non-zero elements, where the non-zero element aᵢⱼ means a non-zero element “a” in (i)th column and (j)th row. Next, among sets of a side (k, l) composed of a given combination of a node k and a node l of a side (k, i), (j, l) to be updated in eliminating the (i)th variable in LU (Lower/Upper) decomposition, a side not existing on the directed graph illustrating circuit matrices is counted as a fill-in parameter and added to the directed graph to acquire an estimated value of the number “b” of fill-in parameters (step S24). The analysis selection unit 223 selects a solution-producing method of a coefficient matrix based on a predicted value calculated by the computation time estimating unit 226 in the same way as for the first embodiment (step S26).

When the analysis selection unit 223 selects the direct method, the circuit matrix generation unit 221 generates a circuit equation (coefficient matrix) as a simultaneous equation using the netlist 21 acquired in the step S22 (step S28). The fill-in parameter generation unit 222B performs advance elimination for the coefficient matrix produced by the circuit matrix generation unit 221 (step S29). At this time, a fill-in parameter is added to the coefficient matrix.

Next, the direct method analyzing unit 224 produces solutions of a coefficient matrix subjected to advance elimination in the step S29 using the direct method and outputs circuit characteristics such as potentials of contacts of a circuit to be analyzed and current values of elements as analysis results (steps S30 and S36). Details of analyzing by the direct method analyzing unit 224 are the same as for the first embodiment, therefore the description is omitted.

When the analysis selection unit 223 selects the iterative method, the circuit matrix generation unit 221 generates a circuit equation (coefficient matrix) as a simultaneous equation using the netlist 21 acquired in the step S22 (step S32). Next, the iterative method analyzing unit 225 produces solutions of a coefficient matrix using the iterative method and outputs circuit characteristics such as potentials of contacts of a circuit to be analyzed and current values of elements as analysis results (steps S34 and S36). Details of analyzing by the iterative method analyzing unit 225 are the same as for the first embodiment, therefore the description is omitted.

As described above, the circuit simulation device 10, before generating a coefficient matrix, estimates parameters required to select a solution-producing method for a coefficient matrix and determine a solution-producing method using the estimated parameters. As a result, advance processing for generating parameters can be performed after determination of a solution-producing method, thus shortening the time required to determine a solution-producing method. Selective use of the iterative method permits implementation of circuit simulation without use of unnecessary advance processing.

The circuit simulation device 10 according to the present invention automatically and exactly can select the higher-speed analysis method of the direct method and the iterative method. This can provide a circuit simulation device capable of analyzing electronic circuits at high speed from small-scaled circuits with small computation volume to large-scaled circuits with large computation volume.

Embodiments of the present invention are as detailed above, but a concrete configuration is not limited to the embodiments, and the present invention includes any change within a scope not departing from the sprit and intent thereof. In the second embodiment, with the art disclosed in Japanese Patent Laid-Open No. 09-319784 as an example, the computing time estimating unit 226 acquires estimated values of a coefficient matrix size N, number “a” of non-zero elements and number “b” of fill-in parameters, but if these estimated values can be obtained more exact or at higher speed, the present invention is not limited to this method.

What is claimed is:

1. A circuit analysis method comprising:
acquiring netlist information corresponding to a circuit to be analyzed;
generating a coefficient matrix corresponding to a circuit equation of the circuit based on the netlist information;
acquiring a fill-in parameter for the coefficient matrix;
selecting either a direct method or an iterative method as a solution-producing method for the coefficient matrix based on the fill-in parameter, a matrix size of the coefficient matrix and number of non-zero elements of the coefficient matrix; and
producing a solution for the coefficient matrix as analysis result of the circuit by a selected one of the direct method and the iterative method.

2. The circuit analysis method according to claim 1, wherein the acquiring the fill-in parameter includes:
performing an advance elimination for the coefficient matrix; and
acquiring the fill-in parameter by counting number of matrix elements filled in the coefficient matrix.

3. The circuit analysis method according to claim 1, further including:
estimating the fill-in parameter, the matrix size and the number of non-zero elements by a directed graph based on the netlist information, wherein the selecting the solution-producing method selects either of the direct method or the iterative method based on the estimated fill-in parameter, the estimated matrix size and the estimated number of non-zero elements.

4. The circuit analysis method according to claim 1, further including:
setting a solution-producing method selection condition as a predetermined value, wherein the selecting the solution-producing method includes:
selecting the iterative method as the solution-producing method if (a+b)²/(a×N)>Fill is satisfied, wherein “a” is the number of non-zero elements, “b” is the fill-in parameter, “N” is the matrix size and “Fill” is the solution-producing method selection condition.

5. The circuit analysis method according to claim 4, wherein the selecting the solution-producing method includes:
selecting the direct method as the solution-producing method if (a+b)²/(a×N)<Fill is satisfied.

6. A computer program product embodied on a computer-readable medium and comprising code that, when executed, causes computer to perform the steps of the method according to claim 1.

7. A circuit simulation device comprising:
a circuit matrix generation unit for generating a coefficient matrix based on netlist information corresponding to a circuit to be analyzed;
a fill-in parameter counting unit for acquiring a fill-in parameter for the coefficient matrix;
an analysis selection unit for selecting either a direct method or an iterative method as a solution-producing method for the coefficient matrix based on the fill-in parameter, a matrix size of the coefficient matrix and number of non-zero elements of the coefficient matrix; and
an analyzing unit for producing a solution for the coefficient matrix as an analysis result of the circuit by a selected one of the direct method and the iterative method.

8. The circuit simulation device according to claim 7, further including a computing time estimating unit for estimating the fill-in parameter, the matrix size and the number of non-zero elements based on the netlist information.

9. The circuit simulation device according to claim 8, wherein the computing time estimating unit estimates the fill-in parameter, the matrix size and the number of non-zero elements by a directed graph based on the netlist information.

10. The circuit simulation device according to claim 7, further including a storage unit for storing a solution-producing method selection condition as a predetermined value, wherein the analysis selection unit selects the iterative method as the solution-producing method if (a+b)²/(a×N)>Fill is satisfied and the analyzing unit produces a solution for the coefficient matrix by the iterative method, wherein “a” is the number of non-zero elements, “b” is the fill-in parameter, “N” is the matrix size and “Fill” is the solution-producing method selection condition.

11. The circuit simulation device according to claim 10, wherein the analysis selection unit selects the direct method as the solution-producing method if (a+b)²/(a×N)<Fill is satisfied and the analyzing unit produces a solution for the coefficient matrix by the direct method.
